(19) United States
(12) Patent Application Publication
(10) Pub. No.: US 2010/0164858 A1
(43) Pub. Date: Jul. 1, 2010

(54) CONTROL CIRCUIT FOR LIGHT-EMITTING ELEMENT

(75) Inventor: Hiroki KIKUCHI, Kyoto (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 12/646,412

(22) Filed: Dec. 23, 2009

(30) Foreign Application Priority Data
Dec. 25, 2008 (JP) 2008-330774

(51) Int. Cl. G09G 3/36; H05B 41/16

(52) U.S. Cl. 345/102; 315/246; 345/99

(57) ABSTRACT

A control circuit generates a driving signal for driving a light-emitting element. An external synchronization oscillator receives a synchronization clock signal from an external circuit, and generates an external synchronization cyclic signal synchronously with the clock signal. An internal oscillator generates an internal cyclic signal having a predetermined frequency asynchronously with the synchronization clock signal. When the frequency of the external synchronization cyclic signal is within a predetermined range, the driving signal generating unit generates the driving signal based upon the external synchronization cyclic signal. When the frequency of the external synchronization cyclic signal deviates from the predetermined range, the driving signal generating unit generates the driving signal based upon the internal cyclic signal.

### BACKGROUND OF THE INVENTION

1. Field of the Invention

The present invention relates to a control technique for controlling a driving operation for a fluorescent lamp or an LED (light-emitting diode).

2. Description of the Related Art

In recent years, liquid crystal displays, which provide a display having a thin shape and a large size, have been becoming popular as replacements for CRT-based TVs. Liquid crystal displays include multiple cold cathode fluorescent lamps (which will be referred to as “CCFLs” hereafter) or external electrode fluorescent lamps (which will be referred to as “EEFLs” hereafter) arranged on the back face of a liquid crystal panel on which video images are to be displayed, which are used as light-emitting backlights. Alternatively, LEDs are coming to be used as replacements for the fluorescent lamps.

The CCFL or EEFL is driven using an inverter (DC/AC converter) which boosts DC voltage of around 12 V, and which outputs the voltage thus boosted in the form of AC voltage, for example. The inverter converts the current flowing through the CCFL into voltage, and returns the voltage thus converted to a control circuit as a feedback voltage, thereby controlling the ON/OFF operation of a switching element based upon the voltage thus fed back. For example, driving techniques for the CCFL using an inverter are disclosed in Patent Documents 1 through 3.

### [Patent Document 1]

Japanese Patent Application Laid Open No. 2003-323994

### [Patent Document 2]

Japanese Patent Application Laid Open No. H7-231697

### [Patent Document 3]

Japanese Patent Application Laid Open No. 2007-143261

Here, let us consider an arrangement in which a control circuit generates a driving signal for turning on an inverter or generates a pulse signal for a burst dimming operation, based upon a synchronization clock signal output from a microcomputer. In some cases, the frequency of a clock signal supplied from a microcomputer can greatly deviate or can be interrupted due to a malfunction of the microcomputer. In such a case, in a case in which the control circuit drives the inverter according to the clock signal, the luminance of the fluorescent lamp cannot be stably supplied, leading to flickering on a screen.

A similar problem can occur in control circuits for light-emitting devices other than a fluorescent lamp, examples of which include a control circuit for an LED driver for driving an LED.

### SUMMARY OF THE INVENTION

The present invention has been made in order to solve such a problem. Accordingly, it is an exemplary purpose of the present invention to provide a technique for driving a light-emitting element with high stability even in a case in which a synchronization clock signal supplied from an external circuit fluctuates.

An embodiment of the present invention relates to a control circuit configured to generate a driving signal for driving a light-emitting element. The control circuit comprises: an external synchronization oscillator configured to receive a synchronization clock signal from an external circuit, and to generate an external synchronization cyclic signal synchronously with the synchronization clock signal; an internal oscillator configured to generate an internal cyclic signal having a predetermined frequency asynchronously with the synchronization clock signal; and a driving signal generating unit configured such that, when the frequency of the external synchronization cyclic signal is within a predetermined range, the driving signal generating unit generates the driving signal based upon the external synchronization cyclic signal, and such that, when the frequency of the external synchronization cyclic signal deviates from the predetermined range, the driving signal generating unit generates the driving signal based upon the internal cyclic signal.

Examples of the “cyclic signals” include cyclic triangle wave signals, sawtooth wave signals, and sine wave signals, in addition to cyclic pulse signals (rectangular wave signals). Also, examples of “light-emitting elements” include fluorescent lamps such as CCFLs, EEFLs, etc., and a wide range of devices driven according to a cyclic signal, such as organic EL (Electro-Luminance) elements, LEDs, etc. With such an arrangement, a driving signal can be generated based upon a signal generated by the internal oscillator. Thus, even in a case in which the frequency of the synchronization clock signal fluctuates or the synchronization clock signal is interrupted, such an arrangement is capable of providing highly stable driving of a light-emitting element.

Also, the external synchronization oscillator may be a PLL (Phase Locked Loop) circuit configured to multiply or divide the synchronization clock signal. Also, the control circuit may further comprise a frequency monitor unit configured to monitor a signal which indicates a level that corresponds to the frequency of the external synchronization cyclic signal that occurs within the PLL circuit, and to compare the signal thus monitored with a predetermined threshold. Also, the driving signal generating unit may be configured to select either the external synchronization cyclic signal or the internal cyclic signal based upon the comparison result obtained by the frequency monitor unit. It should be noted that the division operation includes an operation in which the signal is divided by one. Also, the multiplication operation includes an operation in which the signal is multiplied by one.

Also, the frequency monitor unit may be configured to monitor a signal that corresponds to the output of a loop filter included in the PLL circuit. With such an arrangement, the time period during which the fluctuation of the frequency of the synchronization clock signal is to be masked can be adjusted by optimizing the frequency properties of the loop filter.

Also, hysteresis may be set for the upper limit and the lower limit of the predetermined range.

Also, the light-emitting element may be a fluorescent lamp. Also, the driving signal generating unit may generate a pulse signal for turning on the fluorescent lamp, based upon the external synchronization cyclic signal and the internal cyclic signal.

Also, the light-emitting element may be a fluorescent lamp. Also, the driving signal generating unit may generate a pulse signal for a burst dimming operation for the fluorescent lamp, based upon the external synchronization cyclic signal and the internal cyclic signal.

Another embodiment of the present invention relates to a light-emitting apparatus. The light-emitting apparatus comprises: a fluorescent lamp; and an inverter configured to supply a driving voltage to the fluorescent lamp. The inverter includes a control circuit according to any one of the above-described embodiments.

Yet another embodiment of the present invention relates to a liquid crystal display apparatus. The liquid crystal display apparatus comprises: a liquid crystal panel; and multiple light-emitting apparatuses above described, arranged on the back face of the liquid crystal panel.

Such an embodiment prevents flickering on a screen.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram which shows the configuration of a light-emitting apparatus according to an embodiment of the present invention;

FIG. 2 is a block diagram which shows the configuration of a liquid crystal display mounting the light-emitting apparatus shown in FIG. 1;

FIG. 3 is a circuit diagram which shows the configuration of a control circuit according to an embodiment;

FIG. 4 is a circuit diagram which shows an example configuration of an external synchronization oscillator and a frequency monitor unit shown in FIG. 3; and

FIG. 5 is a time chart which shows the operation of the control circuit shown in FIG. 3.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, the state represented by the phrase “the member A is connected to the member B” includes a state in which the member A is indirectly connected to the member B via another member that does not affect the electric connection therebetween, in addition to a state in which the member A is physically and directly connected to the member B.

In the same way, the state represented by the phrase “the member C is provided between the member A and the member B” includes a state in which the member A is indirectly connected to the member C, or the member B is indirectly connected to the member C via another member that does not affect the electric connection therebetween, in addition to a state in which the member A is directly connected to the member C, or the member B is directly connected to the member C.

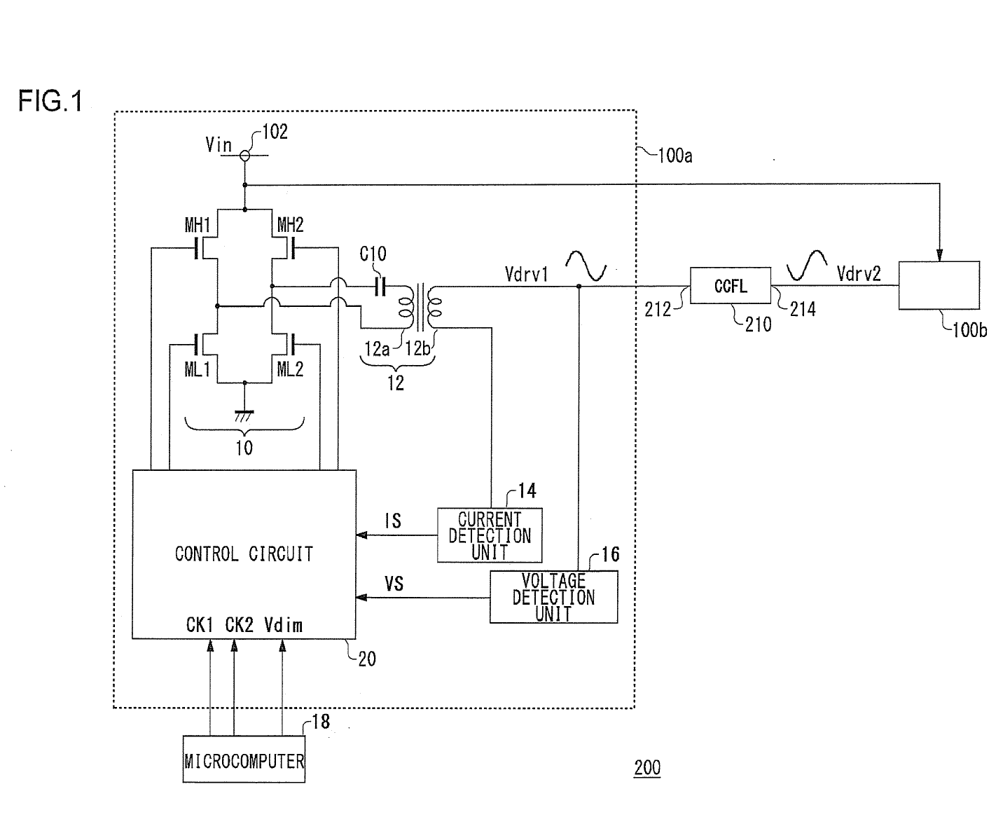

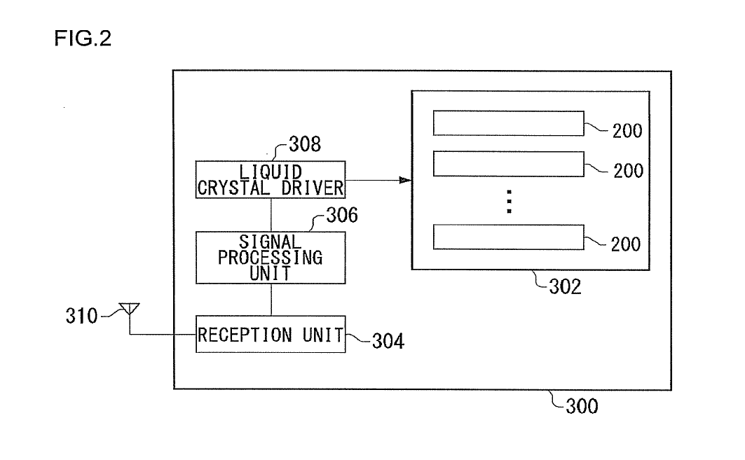

FIG. 1 is a circuit diagram which shows a configuration of a light-emitting apparatus 200 according to an embodiment of the present invention. FIG. 2 is a block diagram which shows a configuration of a liquid crystal display 300 mounting the light-emitting apparatus 200 shown in FIG. 1. First, description will be made regarding the overall configuration of the liquid crystal display 300 with reference to FIG. 2. The liquid crystal display 300 is connected to an antenna 310. The antenna 310 receives broadcast waves, and outputs a received signal to a reception unit 304. The reception unit 304 detects and amplifies the received signal, and outputs the received signal thus detected and amplified to a signal processing unit 306. The signal processing unit 306 outputs image data, which is obtained by decoding the modulated data, to a liquid crystal driver 308. The liquid crystal driver 308 outputs the image data to a liquid crystal panel 302 in increments of scanning lines, thereby displaying video images and still images. Multiple light-emitting devices 200 are arranged as backlights on the back face of the liquid crystal panel 302. The light-emitting apparatus 200 according to the present embodiment is suitably employed as a backlight for such a liquid crystal panel 302. Returning to FIG. 1, detailed description will be made below regarding the configuration and the operation of the light-emitting apparatus 200.

The light-emitting apparatus 200 according to the present embodiment includes a CCFL 210, a first inverter 100a, a second inverter 100b, and a microcomputer 220. The microcomputer 220 controls the overall operations of the light-emitting apparatus 200 and the liquid crystal display 300. The microcomputer 220 generates a first clock signal CK1 for setting the driving frequency (lighting frequency) for the CCFL 210 and a second clock signal CK2 for setting a burst dimming frequency by itself or by using an external circuit, and outputs the clock signals thus generated to a control circuit 20. The CCFL 210 is arranged on the back face of the liquid crystal panel 302. Each of the first inverter 100a and the second inverter 100b is a DC/AC converter which converts an input voltage Vin output from a DC power supply into an AC voltage and boosts the AC voltage thus converted, thereby supplying a first driving voltage Vdrv1 and a second driving voltage Vdrv2 to a first terminal 212 and a second terminal 214 of the CCFL 210, respectively. The first driving voltage Vdrv1 and the second driving voltage Vdrv2 are AC voltages having mutually reverse phases.

While FIG. 1 shows an arrangement including a single CCFL 210, an arrangement may be made including multiple CCFLs 210 arranged in parallel. Also, an arrangement may be made in which the driving voltage Vdrv1 is supplied to only one terminal (212) side of the CCFL 210, and the other terminal (214) side is grounded. Also, the CCFL 210 may be a U-shaped CCFL. Various modifications may be made with respect to the circuit topology, which can be conceived by those skilled in this art.

Description will be made below regarding the configurations of the first inverter 100a and the second inverter 100b according to the present embodiment. The first inverter 100a and the second inverter 100b have the same configuration. Accordingly, these inverters will be collectively referred to as the “inverters 100” without distinguishing between the individual inverters, and description will be made regarding the inverters 100.

The inverter 100 includes an H-bridge circuit 10, a transformer 12, a current detection unit 14, a voltage detection unit 16, a control circuit 20, and a capacitor C10.

The H-bridge circuit 10 includes four power transistors, i.e., a first high-side transistor MH1, a first low-side transistor ML1, a second high-side transistor MH2, and a second low-side transistor ML2.

The first high-side transistor MH1 is arranged with one terminal thereof connected to an input terminal 102 via which the input voltage is applied, and with the other terminal thereof connected to a first terminal of a primary coil 12a. The first low-side transistor ML1 is arranged with one terminal thereof connected to the ground terminal connected to a fixed electric potential, and with the other terminal thereof connected to the first terminal of the primary coil 12a. The second high-side transistor MH2 is arranged with one terminal thereof connected to the input terminal 102, and with the other terminal thereof connected to a second terminal of the primary coil via a capacitor C10 for blocking DC current. The second low-side transistor ML2 is arranged with one terminal thereof connected to the ground terminal, and with the other terminal thereof connected to the second terminal of the primary coil 12a via the capacitor C10 for blocking DC current.

It should be noted that a half-bridge circuit may be employed instead of the H-bridge circuit 10. Also, various modifications may be made with respect to the topology of the circuit including the H-bridge circuit 10 and the transformer 12, which are also encompassed within the scope of the present invention.

The current detection unit 14 is connected to a secondary coil 12b of the transformer 12. The current detection unit 14 converts the current that flows through the secondary coil 12b, i.e., the lamp current that flows through the CCFL 210, into a voltage, and outputs the voltage thus converted as a current detection signal IS. The current detection unit 14 may include a current/voltage conversion circuit which converts the lamp current into voltage, and a low-pass filter which removes the high-frequency components of the output of the current/voltage conversion circuit.

The voltage detection unit 16 generates a voltage detection signal VS that corresponds to the driving voltage Vdrv1 applied to one terminal of the first terminal 212. For example, the voltage detection unit 16 generates the voltage detection signal VS, which is proportional to the driving voltage Vdrv1, using resistive dividers or capacitive dividers.

The control circuit 20 controls the ON/OFF operations of the first high-side transistor MH1, the first low-side transistor ML1, the second high-side transistor MH2, and the second low-side transistor ML2 of the H-bridge circuit 10 based upon the current detection signal IS and the voltage detection signal VS returned as the feedback signals. The H-bridge circuit 10 is controlled so as to supply a switching voltage to the primary coil 12a of the transformer 12. As a result, energy conversion is performed at the transformer 12, and the first driving voltage Vdrv1 is supplied to the CCFL 210 connected to the secondary coil 12b.

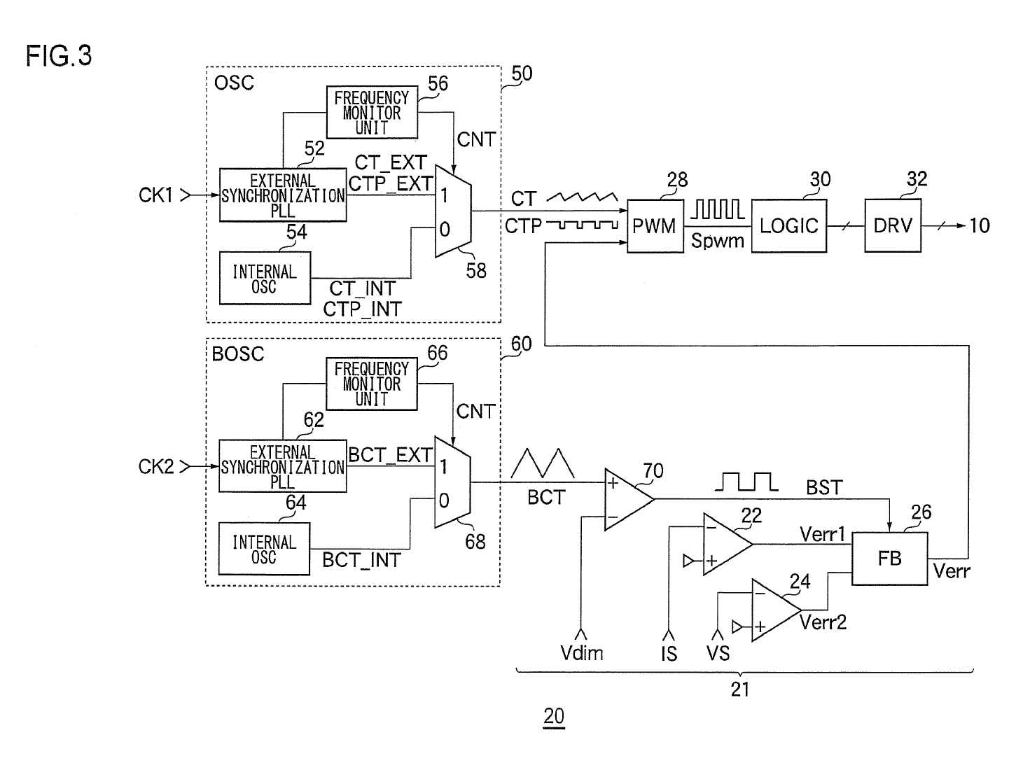

Description will be made below regarding the configuration of the control circuit 20. FIG. 3 is a circuit diagram which shows the configuration of the control circuit 20 according to the embodiment. The control circuit 20 includes a driving signal generating unit 21, a driving frequency oscillator 50, and a burst frequency oscillator 60, and is configured as a function IC monolithically integrated on a single semiconductor substrate.

The driving signal generating unit 21 includes a first error amplifier 22, a second error amplifier 24, a feedback unit 26, a PWM circuit 28, a logic unit 30, a driver 32, a driving frequency oscillator 50, a burst frequency oscillator 60, and a burst dimming comparator 70.

The current detection signal IS fed back from the current detection unit 14 is input to the non-inverting input terminal of the first error amplifier 22. Furthermore, a predetermined reference voltage Vref is input to the inverting input terminal thereof. The reference voltage Vref is determined according to the light-emission luminance to be set for the CCFL 210. The first error amplifier 22 outputs an error voltage Verr1 that corresponds to the difference between the current detection signal VS and the reference voltage Vref.

The voltage detection signal VS fed back from the voltage detection unit 16 is input to the non-inverting input terminal of the second error amplifier 24. Furthermore, a predetermined reference voltage Vref is input to the inverting input terminal thereof. The second error amplifier outputs an error voltage Verr2 that corresponds to the difference between the voltage detection signal VS and the reference voltage Vref.

The feedback unit 26 outputs, as an error voltage Verr, one error signal selected from among the two error signals Verr1 and Verr2. When the error voltage Verr1 is selected, the feedback control operation is performed such that the lamp current approaches its target value. When the error voltage Verr2 is selected, the feedback control operation is performed such that the lamp voltage approaches its target value.

The PWM circuit 28 receives the error voltage

Verr from the feedback unit 26, and a cyclic signal CT generated by the driving frequency oscillator 50. The PWM circuit 28 generates a driving PWM signal having a frequency that corresponds to the cyclic signal CT, and having a duty ratio that corresponds to the error voltage Verr. The cyclic signal CT is any one of a pulse signal, a sawtooth wave, or a triangle wave, or a combination thereof. In order to facilitate understanding, description will be made below regarding an arrangement employing a cyclic signal CT in the form of a triangle wave or a sawtooth wave (which will be simply referred to as “triangle wave” hereafter). A rectangular pulse cyclic signal provided in the form of a rectangular wave will be denoted by “CTP” in order to distinguish it from the cyclic signal CT. The cyclic signal CT is generated by the driving frequency oscillator 50 described later. The cyclic signal CT has a driving frequency (lighting frequency) which is set in a range between 30 kHz and 90 kHz, for example.

The PWM circuit 28 has a configuration including a PWM comparator, for example. The PWM circuit 28 compares the error voltage Verr with the triangle wave cyclic signal CT output from the driving frequency oscillator 50. The PWM circuit 28 generates a PWM signal Spwm based upon the timing of these two signals crossing each other.

The logic unit 30 generates, according to the PWM signal Spwm, a driving signal for the multiple transistors which are components of the H-bridge circuit 10. The driver 32 receives the driving signal from the logic unit 30, and drives the H-bridge circuit 10. Various arrangement may be made for the PWM circuit 28 and the logic unit 30. For example, an arrangement described in Patent Document 3 can be employed.

The driving frequency oscillator 50 receives the first clock signal CK1 from the microcomputer 220 as an input signal. The driving frequency oscillator 50 includes an external synchronization oscillator 52, an internal oscillator 54, a frequency monitor unit 56, and a selector 58. The external synchronization oscillator 52 receives the first clock signal CK1, and generates a triangle wave cyclic signal (external synchronization cyclic signal) CT_EXT synchronously with the first clock signal CK1. Furthermore, the external synchronization oscillator 52 outputs an external synchronization cyclic signal CTP_EXT in the form of a pulse wave, synchronously with the external synchronization cyclic signal CT_EXT, in addition to the external synchronization cyclic signal CT_EXT.

The internal oscillator 54 is an independently-oscillating oscillator which oscillates independently of the first clock signal CK1, and generates a triangle wave cyclic signal (internal cyclic signal) CT_INT having a predetermined frequency. Furthermore, the internal oscillator 54 outputs an internal cyclic signal CTP_INT provided in the form of a pulse wave, synchronously with the internal cyclic signal CT_INT, in addition to the internal cyclic signal CT_INT. The frequency of the internal cyclic signal CT_INT can be set to a desired value. However, the frequency of the internal cyclic signal CT_INT is preferably set to a value around the nominal value (design value) of the frequency of the first clock signal CK1.

The selector 58 receives, as the input signals, the pair of external synchronization cyclic signals CT_EXT and the CTP_EXT and the pair of internal synchronization cyclic signals CT_INT and the CTP_INT. The selector 58 selects one signal pair according to a control signal CNT, and outputs the signal pair thus selected. The frequency monitor unit 56 monitors the external synchronization oscillator 52, and judges whether or not the oscillation frequency of the external synchronization oscillator 52 deviates from a predetermined range. The frequency monitor unit 56 generates the control signal CNT that corresponds to the judgment result. When the frequency is within the predetermined range, the control signal CNT is asserted (1). When the frequency deviates from the range, the control signal CNT is negated (0). Accordingly, when the oscillation frequency is within the predetermined range, the selector 58 selects the external synchronization signal CT_EXT, and when the oscillation frequency deviates from the predetermined range, the selector 58 selects the internal cyclic signal CT_INT.

The selector 58 outputs one cyclic signal CT thus selected to the PWM circuit 28.

The control circuit 20 has a burst dimming function. The burst dimming function is a function for adjusting the perceived brightness level, by intermittently switching on and off the CCFL 210.

The feedback unit 26 receives, as an input signal, a pulse signal (which will be referred to as the “burst pulse” hereafter) BST for a burst dimming operation. The burst pulse BST has a frequency of around 60 to 300 Hz, and has a duty ratio that corresponds to the luminance. When the burst pulse BST is in the high-level state, the CCFL 210 is in the ON state. When the burst pulse BST is in the low-level state, the CCFL 210 is in the OFF state.

When the burst pulse BST is in the high-level state, the feedback unit 26 outputs the error voltage Verr as it is. When the burst pulse BST is in the low-level state, the feedback unit 26 shifts the error voltage Verr to a predetermined electric potential. By error voltage Verr thus shifted, the duty ratio of the PWM signal Spwm generated by the PWM circuit 28, which is a downstream component, is set to 0% (or 100%), thereby switching off the CCFL 210.

The burst pulse BST is generated by the burst frequency oscillator 60 and the burst dimming comparator 70. The burst frequency oscillator 60 generates a cyclic signal BCT in the form of a triangle wave or a sawtooth wave for the burst dimming operation. FIG. 3 shows a triangle wave cyclic signal BCT, as an example.

The burst frequency oscillator 60 receives, as an input signal, the second clock signal CK2 from the microcomputer 220. The burst frequency oscillator 60 includes an external synchronization oscillator 62, an internal oscillator 64, a frequency monitor unit 66, and a selector 68, and has the same configuration as that of the driving frequency oscillator 50.

The external synchronization oscillator 62 receives the second clock signal CK2, and generates a cyclic signal (external synchronization cyclic signal) BCT_EXT in the form a triangle wave or a sawtooth wave synchronously with the second clock signal CK2. The internal oscillator 64 is an independently-oscillating oscillator which oscillates independently of the second clock signal CK2, and generates a triangle wave cyclic signal (internal cyclic signal) CT_INT having a predetermined frequency. The frequency of the internal cyclic signal CT_INT can be set to a desired value. However, the frequency of the internal cyclic signal CT_INT is preferably set to a value around the nominal value (design value) of the frequency of the second clock signal CK2.

The selector 68 selects one cyclic signal from among the external synchronization cyclic signal CT_EXT and the internal cyclic signal CT_INT, and outputs the cyclic signal thus selected as the cyclic signal BCT for the burst dimming operation.

The burst dimming comparator 70 slices the cyclic signal BCT for the burst dimming operation by comparing the cyclic signal BCT with a voltage Vdim set for adjusting the dimming level. The burst dimming comparator 70 outputs the burst pulse BST having a duty ratio which changes according to the dimming level.

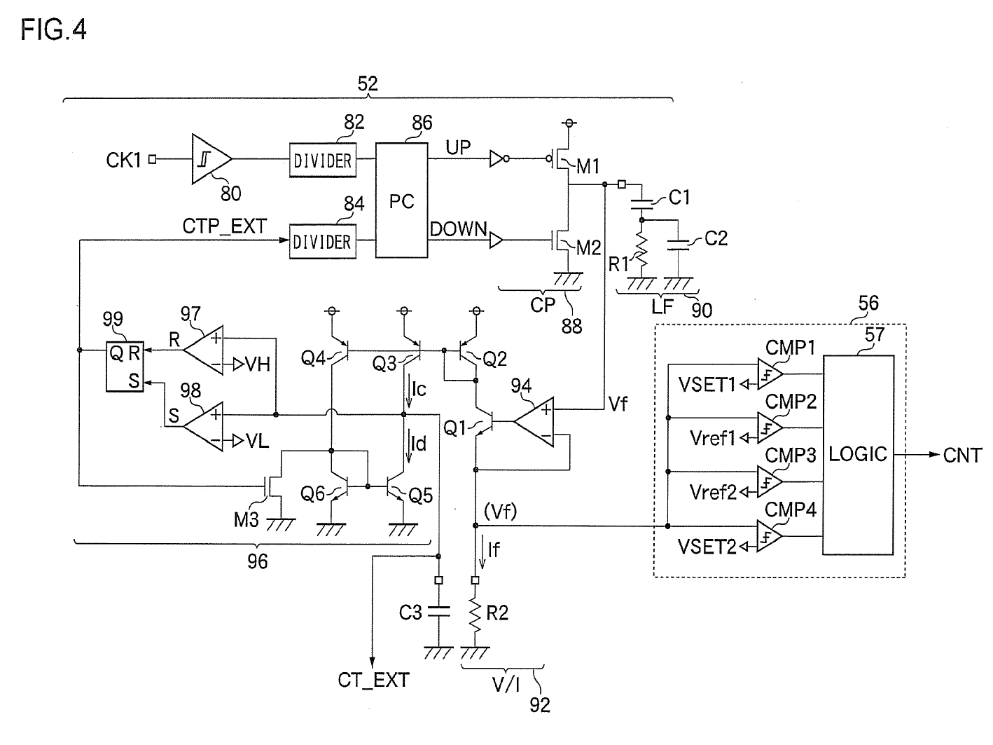

FIG. 4 is a circuit diagram which shows an example configuration of the external synchronization oscillator 52 and the frequency monitor unit 56 shown in FIG. 3.

The external synchronization oscillator 52 includes a hysteresis comparator 80, a first divider 82, a second divider 84, a phase comparator 86, a charge pump circuit 88, a loop filter 90, a V/I conversion circuit 92, and a charge/discharge circuit 96.

The hysteresis comparator 80 performs signal-shaping of the first clock signal CK1 received from an external circuit. A Schmitt buffer may be employed instead of the comparator. Also, in a case in which the duty ratio of the first clock signal CK1 is highly stable, the hysteresis comparator 80 may be eliminated.

The first divider 82 divides, with a predetermined division ratio (e.g., 1/2), the first clock signal CK1′ output from the hysteresis comparator 80. The second divider 84 divides, with a predetermined division ratio (e.g., 1/2), the pulse cyclic signal CTP_EXT generated by the external synchronization oscillator 52. The phase comparator 86 makes a comparison between the phase of the first clock signal CK1″ and the phase of the pulse cyclic signal CTP′, and outputs an UP signal or a DOWN signal based upon the comparison result. The charge pump circuit 88 includes transistors M1 and M2. When the UP signal UP is asserted, the charge pump circuit 88 charges a capacitor C1. When the DOWN signal DOWN is asserted, a capacitor C2 is discharged.

The loop filter 90 is a low-pass filter including the capacitor 02 and a resistor R1, and removes the high-frequency components of the voltage (frequency setting voltage Vf) that occurs at the capacitor C1. The configuration of the loop filter 90 is not restricted in particular. The loop filter 90 may be a passive filter configured by making a desired combination of capacitors, resistors, and inductors, or may be an active filter. Also, the loop filter 90 may be a built-in component included within an IC. Also, the loop filter 90 may be configured using external chip components.

The V/I conversion circuit 92 converts the frequency setting voltage Vf into an electric current If. The V/I conversion circuit 92 includes an operational amplifier 94, a transistor Q1, and a resistor R2. An imaginary short is set at the operational amplifier 94. Accordingly, the frequency setting voltage Vf is applied to the resistor R2. As a result, the frequency setting current If flows through the transistors Q1 and Q2 and the resistor R2.

If=Vf/R2

The charge/discharge circuit 96 charges/discharges a capacitor C3 using the frequency setting current If. The transistors Q2 through Q6 form a current mirror circuit, and duplicates or folds the frequency setting current If.

The capacitor C3 is charged by the charge current Ic that flows through the transistor Q3, and is discharged by the current difference between the current Id that flows through the transistor Q5 and the current Ic, i.e., (Id−Ic). The transistor M3 controls the gate potential of the transistor Q5. The currents Id and Ic are each proportional to the frequency setting current If, and are set according to the size ratio between the transistors.

A comparator 97 compares the voltage CT_EXT at the capacitor C3 with a predetermined high-side threshold voltage VH. When CT_EXT is greater than VH, the comparator 97 asserts the reset signal R so as to reset an RS latch 99. Furthermore, a comparator 98 compares the voltage CT_EXT with a predetermined low-side threshold voltage VL. When CT_EXT is lower than VL, the comparator 97 asserts the set signal S so as to set an RS latch 99.

When the output signal Q of the RS latch 99 is in the high-level state, the transistor M3 is in the ON state and the transistor Q5 is in the OFF state. In this case, the capacitor C3 is charged by the charge current Ic. When the electric potential CT_EXT at the capacitor C3 reaches the threshold voltage VH due to the charge operation, the output signal Q of the RS latch 99 is switched to the low-level state. This switches the transistor M3 to the OFF state, and accordingly, the transistor Q5 is switched to the ON state, thereby discharging the capacitor C3 by the current difference (Id−Ic). When the electric potential CT_EXT at the capacitor C3 is reduced to a level lower than the threshold voltage VL due to the discharge operation, the output signal Q of the RS latch 99 is switched to the high-level state again.

As described above, by repeatedly performing the charge/discharge operations for the capacitor C3, the cyclic triangle wave signal CT_EXT and the cyclic pulse signal CTP_EXT are generated. One of or both of these cyclic signals is supplied to other circuits.

In the external synchronization oscillator 52, the frequency of the frequency signal CT_EXT is proportional to the frequency setting current If, i.e., the frequency setting voltage Vf. Accordingly, by monitoring the frequency setting voltage Vf, the frequency monitor unit 56 judges whether or not the oscillation frequency of the external synchronization oscillator 52 deviates from a predetermined range.

The frequency monitor unit 56 compares the frequency setting voltage Vf with at least two voltages, i.e., an upper limit voltage VFH which defines the upper limit of the frequency range and a lower limit voltage VFL which defines the lower limit thereof. With such an arrangement, when VFL<Vf<VFH, the control signal CNT is asserted (1). When Vf>VFH or Vf<VFH, the control signal CNT is negated.

More preferably, hysteresis is set for each of the upper liming voltage VFH and the lower limit voltage VFL. For example, when the control signal CNT is “1”, the higher limit voltage VFH is switched to a voltage Vset1 set by an external circuit. On the other hand, when the control signal CNT is “0”, the higher limit voltage VFH is switched to a voltage Vref1 generated by an internal circuit included within the frequency monitor unit 56. Here, Vset1 is greater than Vref1.

In the same way, when the control signal CNT is “1”, the lower limit voltage VFL is switched to a voltage Vset2 set by an external circuit. On the other hand, when the control signal CNT is “0”, the lower limit voltage VFL is switched to a voltage Vref2 generated by an internal circuit included within the frequency monitor unit 56. Here, Vset2 is smaller than Vref2.

In the present embodiment, it is assumed that when the frequency of the first clock signal CK1 is stable, the frequency setting voltage Vf is 1.5 V. Furthermore, it is assumed that Vref is 1.6 V, and Vref2 is 1.4 V.

For example, the frequency monitor unit 56 may include four comparators CMP1 through CMP4 which compare the frequency setting voltage Vf with the voltages Vset1, Vref1, Vref2, and Vset2, and a logic unit 57 which generates the control signal CNT based upon the output signals of the four comparators.

It should be noted that the external synchronization oscillator 62 and the frequency monitor unit 66 can be configured in the same way as in FIG. 4.

The above is the configuration of the control circuit 20. Next, description will be made regarding the operation theror.

In some cases, the frequency of the first clock signal CK1 supplied from the microcomputer 220 can greatly deviate or can be interrupted. In such a case, if the driving frequency oscillator 50 generates the cyclic signal CT based upon only the first clock signal CK1, the luminance of the CCFL 210 fluctuates, leading to flickering on a screen.

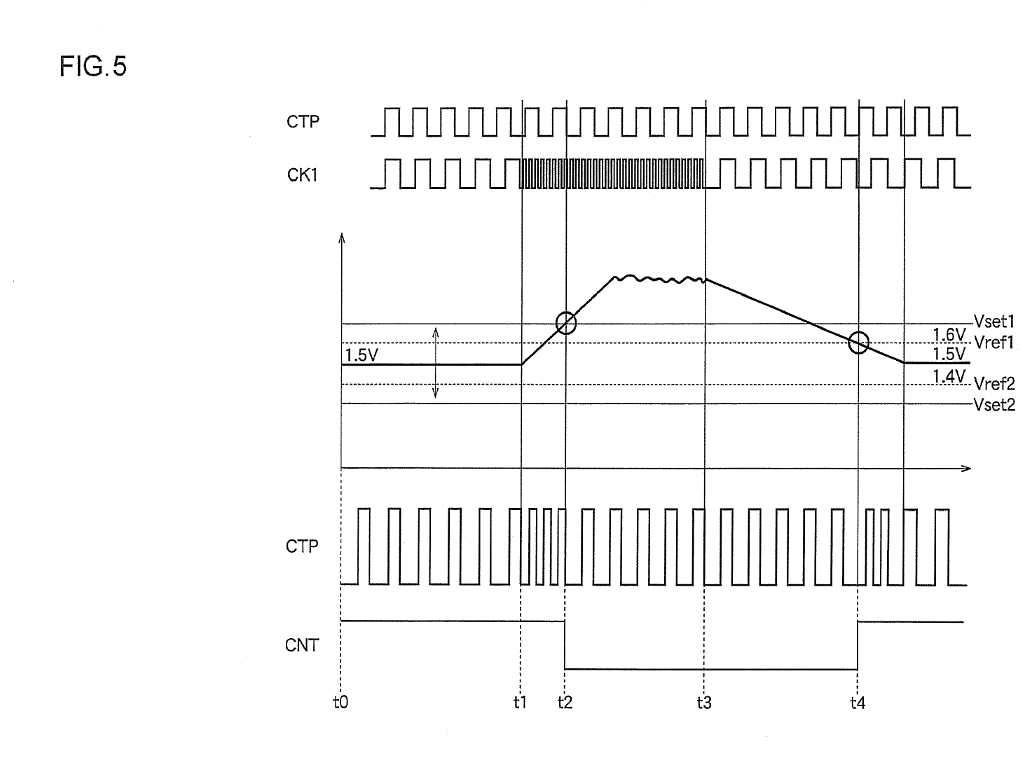

The control circuit 20 according to the embodiment is capable of solving this problem. FIG. 5 is a time chart which shows the operation of the control circuit 20 shown in FIG. 3. During the period of time between t0 and t1, a sufficiently stable first clock signal CK1 is supplied from an external circuit. Furthermore, the internal oscillator 54 generates the internal cyclic signal CTP_INT with a predetermined frequency.

During the period of time between t0 and t1, the frequency setting voltage Vf that occurs within the external synchronization oscillator 52 is stabilized at a predetermined value (1.5 V). In this case, the frequency setting voltage Vf is within a predetermined range, and accordingly, the frequency monitor unit 56 sets the control signal CNT to the high-level state. As a result, the signals CT_EXT and CTP_EXT, which are generated synchronously with the first clock signal CK1, are supplied to circuit blocks such as the PWM circuit 28 and so forth.

When the frequency of the first clock signal CK1 is increased at the point in time t1, the frequency setting voltage Vf that occurs in the external synchronization oscillator 52 starts to rise. Subsequently, the frequency setting voltage Vf exceeds the threshold voltage Vset1 at the point in time t2. In this stage, the control signal CNT is switched to the low-level state, and the internal signals CT_INT and CTP_INT are supplied to the PWM circuit 28.

Subsequently, at the point in time t3, the frequency of the first clock signal CK1 is restored to the original nominal value. As a result, the frequency setting voltage Vf that occurs in the external synchronization oscillator 52 starts to return to the value (1.5 V) to which it is to be set in the normal state. When the frequency setting voltage Vf becomes lower than the first reference voltage Vref1 at the point in time t4, the control signal CNT is switched to the high-level state, thereby supplying the external synchronization signals CT_EXT and CTP_EXT to the PWM circuit 28.

As described above, even in a case in which, due to fluctuation of the first clock signal CK1 supplied from an external circuit, the frequencies of the external synchronization signals CT_EXT and CTP_EXT become undesired values, the control circuit 20 according to the embodiment is capable of generating a stable PWM signal Spwm by immediately switching the cyclic signals to the internal cyclic signals CT_INT and CTP_INT generated asynchronously with the first clock signal CK. As a result, such an arrangement enables the CCFL 210 to continuously emit light, thereby preventing flickering on a screen.

Furthermore, such an arrangement is capable of adjusting the degree of change in the frequency setting voltage Vf which occurs when the first clock signal CK1 fluctuates in accordance with the cutoff frequency of the loop filter 90 in the external synchronization oscillator 52. Thus, by optimizing the cutoff frequency, such an arrangement is also capable of masking fluctuation of the frequency that occurs in an extremely short period of time. Specifically, if the frequency of the first clock signal CK1 is restored to the original frequency before the point in time t2 in the time chart shown in FIG. 5, the control circuit 20 is capable of masking such a fluctuation that occurs in a period of time between the time points t1 and t2.

Furthermore, unlike conventional arrangements, the PLL circuits are provided as built-in components included within the control circuit 20, instead of such PLL circuits being provided in the form of external components for the control circuit 20. Thus, such an arrangement reduces the number of external components, thereby reducing the required mounting area and costs.

The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention.

Description has been made regarding an arrangement in which two oscillators (i.e., an external synchronization oscillator and an internal oscillator) are provided for each of the driving frequency oscillator 50 and the burst frequency oscillator 60. Also, an arrangement may be made in which one oscillator includes these two oscillators, and the other oscillator includes only an internal oscillator.

Description has been made in the embodiment regarding an arrangement as an example, which employs a fluorescent lamp as a light-emitting element to be driven. Also, the control circuit 20 according to the present invention can be employed as a control circuit for other light-emitting elements such as an LED or the like. That is to say, pulse modulation is used for driving the LED. Accordingly, a driving signal is generated for switching a driving current or a driving voltage for the LED in a time-sharing manner. In such a case, the control circuit 20 according to the present invention can be suitably employed in an arrangement in which a synchronization signal, based on which the driving signal is generated, is supplied from an external circuit such as a microcomputer, which is also encompassed in the scope of the present invention.

While the preferred embodiments of the present invention have been described using specific terms, such description is for illustrative purposes only, and it is to be understood that changes and variations may be made without departing from the spirit or scope of the appended claims.

What is claimed is:

1. A control circuit configured to generate a driving signal for driving a light-emitting element, comprising:
an external synchronization oscillator configured to receive a synchronization clock signal from an external circuit, and to generate an external synchronization cyclic signal synchronously with the synchronization clock signal;
an internal oscillator configured to generate an internal cyclic signal having a predetermined frequency asynchronously with the synchronization clock signal; and
a driving signal generating unit configured such that, when the frequency of the external synchronization cyclic signal is within a predetermined range, the driving signal generating unit generates the driving signal based upon the external synchronization cyclic signal, and such that, when the frequency of the external synchronization cyclic signal deviates from the predetermined range, the driving signal generating unit generates the driving signal based upon the internal cyclic signal.

2. A control circuit according to claim 1, wherein the external synchronization oscillator is a PLL (Phase Locked Loop) circuit configured to multiply or divide the synchronization clock signal,
and wherein the control circuit further comprises a frequency monitor unit configured to monitor a signal which indicates a level that corresponds to the frequency of the external synchronization cyclic signal that occurs within the PLL circuit, and to compare the signal thus monitored with a predetermined threshold,
and wherein the driving signal generating unit is configured to select either the external synchronization cyclic signal or the internal cyclic signal based upon the comparison result obtained by the frequency monitor unit.

3. A control circuit according to claim 2, wherein the frequency monitor unit is configured to monitor a signal that corresponds to the output of a loop filter included in the PLL circuit.

4. A control circuit according to claim 1, wherein hysteresis is set for the upper limit and the lower limit of the predetermined range.

5. A control circuit according to claim 1, wherein the light-emitting element is a fluorescent lamp,
and wherein the driving signal generating unit generates a pulse signal for turning on the fluorescent lamp, based upon the external synchronization cyclic signal and the internal cyclic signal.

6. A control circuit according to claim 1, wherein the light-emitting element is a fluorescent lamp,
and wherein the driving signal generating unit generates a pulse signal for a burst dimming operation for the fluorescent lamp, based upon the external synchronization cyclic signal and the internal cyclic signal.

7. A light-emitting apparatus comprising:
a fluorescent lamp; and
an inverter configured to supply a driving voltage to the fluorescent lamp,
wherein the inverter includes a control circuit according to claim 1.

8. A liquid crystal display apparatus comprising:
a liquid crystal panel; and
a plurality of light-emitting apparatuses according to claim 7, arranged on the back face of the liquid crystal panel.
